(19) United States
(12) Patent Application Publication
(10) Pub. No.: US 2026/0031271 A1
(43) Pub. Date: Jan. 29, 2026

(54) ISOLATION TRANSFORMER WITH AUTOVOLTAGE REGULATION

(71) Applicant: SCHNEIDER ELECTRIC IT CORPORATION, Foxboro, MA (US)

(72) Inventors: WeiMao Lin, Taipei (TW); Xiaojun Wang, HangZhou (CN)

(21) Appl. No.: 18/783,934

(22) Filed: Jul. 25, 2024

(51) Int. Cl. H01F 29/02; H01F 27/32; H01F 27/40

(52) U.S. Cl. CPC H01F 29/025; H01F 27/324; H01F 27/40

(57) ABSTRACT

A transformer assembly is presented, including a first input; a second input; a first output; a second output; a first winding including a first tap, a second tap, a third tap, and a fourth tap, a first switching device having a first input terminal, a first tap terminal coupled to the first tap, a second tap terminal coupled to the second tap, the first switching device being configured to couple the first input terminal to the first tap terminal or the second tap terminal, and a second switching device having a second input terminal, a third tap terminal coupled to the third tap, a fourth tap terminal coupled to the fourth tap, the second switching device configured to couple the second input terminal to the third tap terminal or the fourth tap terminal; and a second winding coupled to the first output and the second output.

### BACKGROUND

### 1. Field of the Disclosure

At least one example in accordance with the present disclosure relates generally to transformers with automatic voltage regulation (AVR) functionality.

### 2. Discussion of Related Art

Transformers may be used to change one voltage to another voltage through induction. The change between voltages is related to the number of turns in the windings of the transformer.

### SUMMARY

According to at least one aspect of the present disclosure, a transformer assembly is provided, comprising: a first input; a second input; a first output; a second output; a first winding including a first tap, a second tap, a third tap, and a fourth tap, a first switching device having a first input terminal, a first tap terminal coupled to the first tap, a second tap terminal coupled to the second tap, the first switching device being configured to selectively couple the first input terminal to the first tap terminal or the second tap terminal, and a second switching device having a second input terminal, a third tap terminal coupled to the third tap, a fourth tap terminal coupled to the fourth tap, the second switching device being configured to selectively couple the second input terminal to the third tap terminal or the fourth tap terminal; and a second winding galvanically isolated from the first winding and coupled to the first output and the second output.

In some examples, the first input terminal is coupled to the first input. In some examples, the second input terminal is coupled to the second input. In some examples, the first winding includes a first end and a second end, and the first tap is situated at the first end, the fourth tap is situated at the second end, the second tap is situated between the first tap and the fourth tap, and the third tap is situated between the second tap and the fourth tap. In some examples, the first winding includes a first section, a second section, and a third section, wherein the first tap is coupled to a first end of the first section, the second tap is coupled to a second end of the first section, the third tap is coupled to a first end of the second section, and the fourth tap is coupled to a second end of the second section. In some examples, the first tap is further coupled to the first input, the third tap is coupled to the first input terminal, a first end of the third section is coupled to the second input terminal, and a second end of the third section is coupled to the second input. In some examples, the first section, second section, and third section are physically separate sections. In some examples, the second tap and third tap are a same tap, a first end of the third section is coupled to the second input terminal, a second end of the third section is coupled to the second input, and the first input terminal is coupled to the first input. In some examples, the first section and second section are physically separate from the third section. In some examples, the first winding includes a fourth section having a first end of the fourth section and a second end of the fourth section, wherein a fifth tap is coupled to the first end of the fourth section, and a sixth tap is coupled to the second end of the fourth section, and the transformer further comprises a third switch having a third input terminal, a fifth tap terminal coupled to the fifth tap, and a sixth tap terminal coupled to the sixth tap. In some examples, the first end of the third section is coupled to the third input terminal, the fifth tap is coupled to the second input terminal, the third tap is coupled to the first input terminal, and the first end of the first section is coupled to the first input. In some examples, the first section, second section, third section, and fourth section are physically separate sections. In some examples, the transformer assembly further comprises a core electromagnetically coupled to the first winding and the second winding.

According to at least one aspect of the present disclosure, a method of regulating a voltage is presented, comprising: provide a voltage to a first winding of a transformer; determine that an output voltage provided by a second winding of the transformer has changed by a threshold amount; responsive to determining that the output voltage has changed by a threshold amount, setting a first switch position of a first switch to one of a first state of the first switch and a second state of the first switch, the first state of the first switch configured to provide the voltage to a first section of the first winding, and the second state of the first switch configured to disconnect the first section of the first winding from the voltage; responsive to determining that the output voltage has changed by a threshold amount, setting a second switch position of a second switch to one of a first state of the second switch and a second state of the second switch, the first state of the second switch configured to provide the voltage to a second section of the first winding, and the second state of the second switch configured to disconnect the second section of the first winding from the voltage; and responsive to determining that the output voltage has changed by a threshold amount, providing the voltage to a third section of the first winding regardless of the first switch position or the second switch position.

In some examples, the method further comprises, responsive to determining that the output voltage has changed by a threshold amount, setting a third switch position of a third switch to one of a first state of the third switch and a second state of the third switch, the first state of the third switch configured to provide the voltage to a fourth section of the first winding, and the second state of the third switch configured to disconnect the third section of the first winding from the voltage. In some examples, the voltage is provided to the third section regardless of the third switch position. In some examples, providing the voltage to the second section of the first winding further includes providing the voltage to the second section from the first switch.

According to at least one aspect of the present disclosure, a non-transitory computer-readable medium is presented, the medium containing thereon instructions for regulating voltages, the instructions instructing one or more processors to: receive an indication of an output voltage and an input voltage of a transformer; determine whether the output voltage has changed by a threshold amount; responsive to determining that the output voltage has changed by a threshold amount, adjust a first switch position of a first switch of a transformer to selectively provide or remove the input voltage from a first section of the first winding; responsive to determining that the output voltage has changed by the threshold amount, adjust a second switch position of a second switch of the transformer to selectively provide or remove the input voltage from a second section of the first winding; and provide the input voltage to a third section of the first winding regardless of the first switch position and the second switch position.

In some examples, the instructions further instruct the one or more processors to, responsive to determining that the output voltage has changed by a threshold amount, adjust a third switch position of a third switch of the transformer to selectively provide or remove the input voltage from a fourth section of the first winding; and provide the input voltage to the third section regardless of the third switch position. In some examples, the input voltage is a voltage associated with the first winding, and the output voltage is a voltage associated with a second winding.

According to at least one aspect of the present disclosure, a transformer assembly is presented, comprising: a first input; a second input; a first winding having a plurality of sections including a first section and a last section, a first end of the first section being coupled to the first input and a second end of the last section being coupled to the second input; a plurality of switches including a first switch configured to selectively couple the first end of the first section or a second end of the first section to a first end of a next section, and a last switch configured to couple a first end of the last section to a first end of a penultimate section or a second end of the penultimate section; and a second winding galvanically isolated from the first winding.

According to at least one aspect of the present disclosure, a transformer assembly is presented, comprising: a first input; a second input; a first winding having a plurality of sections including a first section having a first end of the first section and a second end of the first section, a last section having a first end of the last section and a second end of the last section, a next section having a first end of the next section, and a penultimate section having a first end of the penultimate section and a second end of the penultimate section, the second end of the last section being coupled to the second input, and the second end of the first section being coupled to the first end of the next section; a plurality of switches including a first switch and a last switch, the first switch being coupled to the first input, the first end of the first section, and the second end of the first section, and configured to selectively couple the first input to the first end of the first section or the second end of the first section, and the second switch being coupled to the first end of the last section, the first end of the penultimate section, and the second end of the penultimate section, the last switch configured to selectively couple the first end of the last section to the first end of the penultimate section or the second end of the penultimate section; and a second winding galvanically isolated from the first winding.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a transformer assembly according to an example;

FIG. 2 illustrates a transformer assembly according to an example;

FIG. 3 illustrates a transformer assembly according to an example;

FIG. 4 illustrates a transformer assembly according to an example;

FIG. 5 illustrates a transformer assembly according to an example;

FIG. 6 illustrates a power system according to an example; and

FIG. 7 illustrates a process for providing an output voltage according to an example.

### DETAILED DESCRIPTION

Automatic voltage regulator transformers (“AVR transformers”) disclosed herein receive an input voltage and transform that voltage into an output voltage. The input voltage may fluctuate, for example by falling or rising, however the output voltage remains constant or within a range of acceptable output voltages. AVR transformers disclosed herein can use fewer switches than traditional topologies, and thus can require fewer materials, use less space for at least control systems, be more robust, have less insertion loss, and have improved characteristics relative to the traditional topologies. Furthermore, in some examples, the windings used may be smaller compared to traditional topologies providing the same ranges of voltage regulation.

Isolation transformers disclosed herein, which may include AVR transformers disclosed herein, may also have set winding lengths of each section of the transformers, and may have predetermined lengths, cross-sectional areas, and other characteristics.

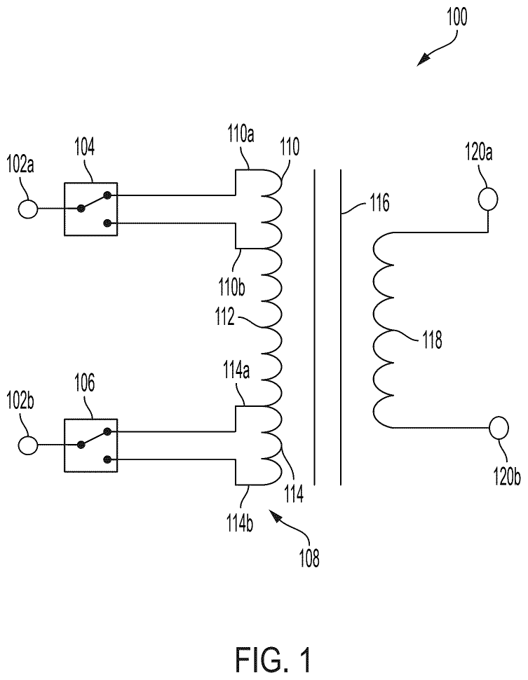

FIG. 1 illustrates a first AVR transformer assembly 100 (“transformer assembly 100”) according to an example. The transformer assembly 100 includes a first input 102a, a second input 102b, a first switch 104, a second switch 106, a first winding 108 having a first section 110, a second section 112, and a third section 114, a core 116, a second winding 118, a first output 120a, and a second output 120b. The transformer assembly 100 is able to receive different input voltages on the first winding 108 while providing a constant or approximately constant (e.g., within a set voltage range) output voltage on the second winding 118.

The first input 102a is coupled to a first terminal of the first switch 104. The first switch 104 has three terminals, including the first terminal coupled to the first input 102a, and a second terminal coupled to a first tap 110a of the first section 110, and a second terminal coupled to a second tap 110b of the first section 110. The first section 110 is coupled to the second section 112 at a location corresponding to the second tap 110b of the first section 110. The second section 112 is coupled to a first tap 114a of the third section 114. The second switch 106 has three terminals, including the first terminal coupled to second input 102b, a second terminal coupled to the first tap 114a of the third section 114, and a third terminal coupled to the second tap 114b of the third section 114. The first output 120a is coupled to a first end of the second winding 118, and the second output 120b is coupled to a second end of the second winding 118. The core 116 may be situated between or within the windings 108, 118.

The first input 102a and second input 102b are configured to provide an input voltage across the first winding 108. The first output 120a and second output 120b are configured to provide an output voltage, based on the input voltage, to a circuit or device.

In operation, the switches 104, 106 selectively couple taps 110a, 110b, 114a, 114b of the first winding 108 to the first input 102a and second input 102b. There are two switches 104, 106 illustrated in FIG. 1, each switch having two states. As a result, there are four total states (as will be discussed in more detail below) for the two switches 104, 106 collectively. This results in four possible conducting paths between the first input 102a and the second input 102b. These conducting paths each pass through the first input 102a, first switch 104, second switch 106, and second input 102b. However, each conducting path has a different length based on which taps 110a, 110b, 114a, 114b it passes through. The four possible combinations are (1) through the first tap 110a of the first section 110 through the first tap 114a of the second section 114, (2) through the first tap 110a of the first section 110 through the second tap 114b of the second section 114, (3) through the second tap 110b of the first section 110 through the first tap 114a of the second section 114, and (4) through the second tap 110b of the first section 110 through the second tap 114b of the second section 114.

The different conducting paths have different numbers of windings, different lengths, and/or different regions that are active (i.e., have a voltage across them or a current passing through them). As a result, the output voltage and/or current induced on the second winding 118 can have different values depending on the input voltage and the length of the first winding 108. In particular, depending on the input voltage and the selected length of the first winding 108, the input voltage and output voltage can be the same, the input voltage can be less than the output voltage, or the input voltage can be greater than the output voltage. For example, as an AVR transformer, the transformer assembly 100 can be operated to provide a constant or relatively constant output voltage on the second winding 118. Thus, if the input voltage increases or decreases beyond a threshold amount, such that the output voltage is no longer within the acceptable output voltage range, the length of the first winding 108 can be effectively changed by switching the states of the switches 104, 106 to either lengthen (by increasing the number of turns on the first winding 108 by choosing a longer conducting path) or shorten (by decreasing the number of turns on the first winding 108 by choosing a shorter conducting path) the first winding 108. This changes the ratio of turns between the first winding 108 and the second winding 118, thereby changing the output voltage.

For example, the relationship between an input voltage and output voltage is, in some examples given by the equation:

$${V}_{s} = {V}_{p} \frac{{N}_{s}}{{N}_{p}} \qquad ( 1 )$$

where Vₚ is the voltage on the primary winding (here, the first winding 108), Nₛ is the number of turns of the secondary winding (here, the second winding 118), Nₚ is the number of turns of the primary winding, and Vₛ is the voltage of the secondary winding. Thus, when Nₚ is less, Vₛ increases, and when Nₚ is greater, Vₛ decreases. If it is desired to maintain a constant Vₛ while Vₚ is variable, then the number of turns of the first winding 108 and/or the second winding 118 may be changed to ensure that Vₛ is kept constant or within an acceptable range.

The second winding 118 may also include switches and taps in the same way as the first winding 108, though said switches and taps are not illustrated here. However, it is possible to adjust the output voltage by changing the number of turns of the second winding 118 as well.

Furthermore, the second winding 118 may have a length equal to or greater than the first section 110, second section 112, third section 114, or a combination of two or more of the first section 110, second section 112, or third section 114. The core 116 may similarly be sized to be longer or shorter than the first winding 108 or second winding 118. The overlap in length of given sections and/or the core with the second winding 118 may further affect the voltage characteristics of the transformer.

Likewise, the sections 110, 112, 114 need not be of uniform length. For example, any one of the sections 110, 112, 114 may be a longest section, any one of the sections 110, 112, 114 may be a shortest section, and any one of the sections 110, 112, 114 may have a length between that of the shortest section and the longest section. That is, the sections 110, 112, 114 may all have distinct and different lengths. However, in some examples, some or all sections 110, 112, 114 may have the same length as other sections 110, 112, 114.

As mentioned above, the switch states determine the effective length of the first winding 108. The first switch 104 has at least two states, including one in which the first terminal of the first switch 104 is coupled to the second terminal of the first switch 104 and the first tap 110a of the first section 110, and another in which the first terminal is coupled to the third terminal of the first switch 104 and the second tap 110b of the first section 110. The second switch 106 has at least two states, including one in which the first terminal of the second switch 106 is coupled to the second terminal of the second switch 106 and the first tap 114a of the third section 114, and another in which the first terminal is coupled to the third terminal of the second switch 106 and the second tap 114b of the third section 114. As a result, depending on the lengths of each section 110, 112, 114 of the first winding 108, the switches 104, 106 can support up to four modes of operation.

For the purposes of example, suppose in one possible embodiment the third section 114 has 20 turns, the second section 112 has 80 turns, and the first section 110 has 7 turns, while the second winding 118 has 100 total turns. When the first switch 104 has selectively coupled the first tap 110a of the first section 110 to the first input 102a, all 7 turns of the first section 110 are part of the conducting path from the first input 102a to the second input 102b, and therefore are effectively part of the first winding 108. When the first switch 104 has selectively coupled the second tap 110b of the first section 110 to the first input 102a, none of the turns of the first section 110 are part of the conducting path and thus are effectively not part of the first winding 108. Put another way, when the first switch 104 couples the first tap 110a to the first input 102a, the number of turns of the first winding 108 increases by 7, and when the first switch 104 couples the second tap 110b to the first input 102a, the number of turns of the first winding 108 decreases by seven.

Likewise, the second switch 106 operates similarly. When the second switch 106 selectively couples the first tap 114a of the third section 114 to the second input 102b, the third section 114 and its 20 turns are effectively not part of the first winding 108, while when the second switch 106 selectively couples the second tap 114b of the third section 114 to the second input 102b, the third section 114 and its 20 turns are effectively part of the first winding 108. In other words, when the second switch 106 couples the first tap 114a to the second input 102b, the number of turns of the first winding 108 decreases by 20 turns, while when the second switch 106 couples the second tap 114b to the second input 102b, the number of turns of the first winding 108 increases by 20 turns.

The second section 112 is, in this example, always part of the first winding 108 and thus the first winding has a minimum number of turns of 80 and a maximum number of turns of 107, with two middle values of 87 turns and 100 turns also possible. Accordingly, the possible modes and approximate output voltages are summarized in the table below:

TABLE 1
Modes of Operation

| | Input | Output Voltage (relative to | |
|---|---|---|---|
| Mode | Voltage | input voltage) | |
| Double Boost | Vin | 1.25 | Vin |
| Boost | Vin | 1.15 | Vin |
| Normal | Vin | 1.0 | Vin |
| Trim | Vin | 0.93 | Vin |

The double boost mode occurs when only the second section 112 is part of the first winding 108. The boost mode occurs when the first section 110 and second section 112 are part of the first winding 108. The normal mode occurs when the second section 112 and third section 114 are part of the first winding 108. And the trim mode occurs when the first, second, and third sections 110, 112, 114 are part of the first winding 108. Thus, if the input voltage falls substantially, the double boost mode can be used to maintain an output voltage within an acceptable range. If the input voltage falls slightly, the boost mode can be used to maintain the output voltage within the acceptable range. If the input voltage rises, the trim mode can be used to maintain the output voltage within the acceptable range. The normal mode may be used when the input voltage falls within a range producing an output voltage in an acceptable range without the use of the double boost, boost, or trim modes.

The example discussed above, with respect to the table, contemplates boost and trim modes. However, other arrangements are also possible, including arrangements with only boost modes, or only trim modes, or additional boost and/or trim modes, and so forth. For example, if it is known that the input voltage will always be greater than or equal to the acceptable output voltage range, the number of turns of each section can be increased so that there are multiple trim modes available. For example, if the second section 112 had 100 turns instead of 80, then the maximum output voltage would be 1.0 Vin, the minimum output voltage would be 0.79 Vin, and there would be two modes between 0.79 Vin and 1.0 Vin.

Normal, boost, double boost, trim, and similar terms are terms of convenience and should not be construed as limiting. For the purpose of consistency and clarity hereafter, normal mode shall refer to a mode where the output voltage equals the input voltage or is within an acceptable range of the input voltage, boost modes shall refer to modes where the output voltage is greater than the input voltage, and trim modes shall refer to modes where the output voltage is less than the input voltage.

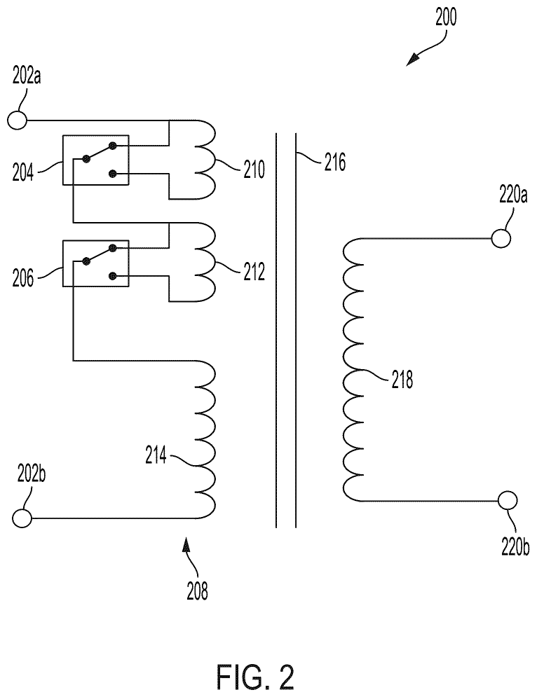

FIG. 2 illustrates a second AVR transformer assembly 200 (“transformer assembly 200”) according to an example. The transformer assembly 200 is similar in some respects to the transformer assembly 100 of FIG. 1. In particular, the transformer can also regulate the output voltage (that is, keep the output voltage within an acceptable range of voltages) using switches to adjust the effective length of the primary winding.

The transformer assembly 200 includes a first input 202a, a second input 202b, a first switch 204, a second switch 206, a first winding 208 having a first section 210, second section 212, and third section 214, a core 216, a second winding 218, a first output 220a, and a second output 22b. In some examples of the transformer assembly 200, the sections 210, 212, 214 may not be coupled together except via the switches 204, 206. That is, in some examples, the sections 210, 212, 214 may be physically distinct sections as opposed to one continuous winding. However, a continuous winding is also possible.

The first input 202a is coupled to a first end of the first section 210. The first switch 204 is coupled to the first end, a second end of the first section 210, and a first end of the second section 212. The second switch 206 is coupled to the first end of the second section 212, a second end of the second section 212, and a first end of the third section 214. The second input 202b is coupled to a second end of the third section 214. The first output 220a is coupled to a first end of the second winding 218, and the second output 220b is coupled to a second end of the second winding 218. The core 216 may be situated in or near the windings 208, 218.

In some examples, the third section 214 is always part of the conducting path between the first input 202a and second input 202b regardless of the state of the switches 204, 206.

The second section 212 may be part of the conducting path depending on the state of the second switch 206. For example, the second switch 206 may have three terminals, including a first terminal coupled to the first end of the third section 214, and two other terminals coupled, respectively, to the first and second ends of the second section 212. The second switch 206 may be configured to selectively couple the first terminal to one of the other two terminals. In a first state, when the first terminal is coupled to a second terminal, the second terminal being coupled to the first end of the second section 212, the second section 212 may not be part of the first winding 208 and/or the conducting path between the first input 202a and second input 202b. In a second state, when the first terminal is coupled to a third terminal, the third terminal being coupled to the second end of the second section 212, the second section 212 may be part of the first winding 208 and/or the conducting path.

Likewise, the first switch 204 may have two states wherein, in a first state, the first terminal of the first switch 204, coupled to the first end of the second section 212, is coupled to a second terminal of the first switch 204, the second terminal being coupled to the first end of the first section 210, and, in a second state, the first terminal may be coupled to a third terminal, the third terminal being coupled to the second end of the first section 210. Thus, when the first switch 204 is in the first state the first section 210 may not be part of the first winding 208 and/or conducting path, and in the second state the first section 210 may be part of the first winding 208 and/or conducting path.

As a result, the number of turns (that is, the length) of the first winding 208 may be adjusted depending on the state of the switches. There are four modes of operation corresponding to the possible lengths of the first winding 208, with the modes depending on the number of turns present.

As an example, suppose the third section 214 has 80 turns, the second section 212 has 20 turns, and the first section 210 has 7 turns. Suppose the second winding 218 has 100 turns. Then the transformer assembly 200 may operate in a double boost mode when only the third section 214 is part of the first winding 208, may operate in a boost mode when only the third and first sections 214, 210 are part of the first winding 208, may operate in the normal mode when the third and second sections 214, 212 are part of the first winding 208, and may operate in a trim mode when all three sections 214, 212, 210 are part of the first winding 208. Note that, in this context, being part of the first winding 208 and being part of the conducting path between the first input 202a and the second input 202b have the same meaning. The different operating modes are summarized in Table 2, below.

TABLE 2
Modes of Operation of Second AVR Transformer

| | Connected Sections of | Output Voltage (relative | |
|---|---|---|---|
| Mode | First Winding | to input voltage) | |
| Double Boost | Third | 1.25 | Vin |
| Boost | Third and First | 1.15 | Vin |
| Normal | Third and Second | 1.0 | Vin |
| Trim | Third, Second, and First | 0.93 | Vin |

The relative lengths, positions, overlaps, and so forth, of the different windings 208, 218, the core 216, and the sections 210, 212, 214 may vary in the same ways as described with respect to FIG. 1 and topology 100.

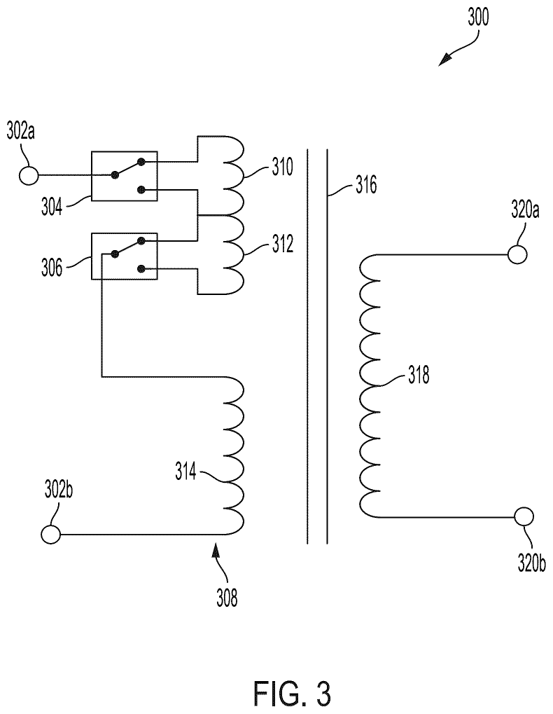

FIG. 3 illustrates a third AVR transformer assembly 300 (“transformer assembly 300”) according to an example. The transformer assembly 300 includes a first input 302a, a second input 302b, a first switch 304, a second switch 306, a first winding 308 having a first section 310, second section 312, and third section 314, a core 316, a second winding 318, a first output 320a, and a second output 320b.

The first input 302a is coupled to a first terminal of the first switch 304. The first switch 304 is coupled to the first and second end of the first section 310 via respective second and third terminals. The second switch 306 is coupled to the first end of the third section 314 via a first terminal, and to the first and second ends of the second section 312 via respective second and third terminals. The second input 302b is coupled to a second end of the third section 314. The first output 320a is coupled to a first end of the second winding 318, and the second output 320b is coupled to a second end of the second winding 318. The core 316 may be situated in or near the windings 308, 318. Finally, the first end of the second section 312 and the second end of the first section 310 are coupled together (or, in some examples, are the same).

This topology 300 functions in a similar manner to the topology 200 of FIG. 2.

As an example, when the first terminal of the first switch 304 is coupled to second terminal (and therefore the first end of the first section 310), the first section 310 is part of the first winding 308. When the first terminal of the first switch 304 is coupled to the third terminal, the first section 310 is not part of the first winding 308. When the first terminal of the second switch 306 is coupled to the first end of the of the second section 312, the second section 312 is not part of the first winding 308. When the first terminal of the second switch 306 is coupled to the second end of the second section 312, the second section 312 is part of the first winding 308. The third section 314 may always be part of the first winding 308.

Note that in the topology 200 of FIG. 2, the first terminal of the first switch 204 was coupled to the third terminal for the first section 210 to be part of the first winding 208. The situation in topology 300 is reversed, with the first terminal of the first switch 304 being coupled to the second terminal for the first section 310 to be part of the first winding 308.

In keeping with prior examples, suppose the third section 314 has 80 turns, the second section 312 has 20 turns, and the first section 310 has 7 turns. Suppose the second winding 318 has 100 turns. Then the transformer assembly 300 may operate in a double boost mode when only the third section 314 is part of the first winding 308, and may operate in a boost mode when the third and first sections 314, 310 are part of the first winding 308. The transformer assembly 300 may operate in a normal mode when the third and second sections 314, 312 are part of the first winding 308, and may operate in a trim mode when all three sections 314, 312, 310 are part of the first winding 308.

TABLE 3
Modes of Operation of Third AVR Transformer

| | Connected Sections of | Output Voltage (relative | |
|---|---|---|---|
| Mode | First Winding | to input voltage) | |
| Double Boost | Third | 1.25 | Vin |
| Boost | Third and First | 1.15 | Vin |
| Normal | Third and Second | 1.0 | Vin |
| Trim | Third, Second, and First | 0.93 | Vin |

The relative lengths, positions, overlaps, and so forth, of the different windings 308, 318, the core 316, and the sections 310, 312, 314 may vary in the same ways as described with respect to FIG. 1 and topology 100.

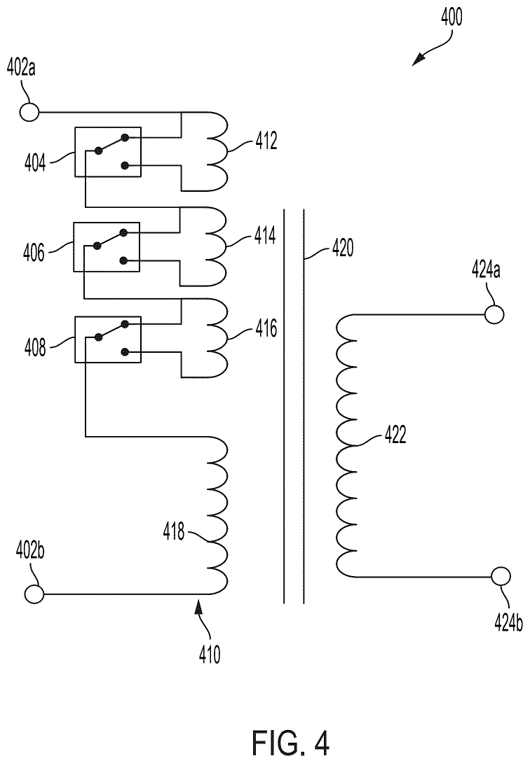

FIG. 4 illustrates a fourth AVR transformer assembly 400 (“transformer assembly 400”) according to an example. The transformer assembly 400 is generally similar to transformer assembly 200 of FIG. 2 except that an additional switch and section of the first winding is present, which increases the number of modes of operation.

The transformer assembly 400 includes a first input 402a, a second input 402b, a first switch 404, a second switch 406, a third switch 408, a first winding 410 having a first section 412, a second section 414, a third section 416, and a fourth section 418, a core 420, a second winding 422, a first output 424a, and a second output 424b.

The first input 402a is coupled to a first end of the first section 412. A first terminal of the first switch 404 is coupled to a first end of the second section 414, a second terminal of the first switch 404 is coupled to the first end of the first section 412, and a third terminal of the first switch 404 is coupled to a second end of the first section 412. A first terminal of the second switch 406 is coupled to a first end of the third section 416, a second terminal of the second switch 406 is coupled to a first end of the second section 414, and a third terminal of the second switch 406 is coupled to the second end of the second section 414. A first terminal of the third switch 408 is coupled to the first end of the fourth section 418, a second terminal of the third switch 408 is coupled to the first end of the third section 416, and a third terminal of the third switch 408 is coupled to the second end of the third section 416. The second input 402b is coupled to the second end of the fourth section 418. The core 420 may be interposed within and/or between the first and second windings 410, 422. The first output 424a is coupled to a first end of the second winding 422, and the second output 424b is coupled to a second end of the second winding 422.

Each switch 404, 406, 408 has two states, a first state when the respective switch's respective first terminal is selectively coupled to the respective second terminal, and a second state when the first terminal is coupled to the respective third terminal. When the first switch 404 is in the first state, the first section 412 is not part of the first winding 410. When the first switch 404 is in the second state, the first section 412 is part of the first winding 410. When the second switch 406 is in the first state, the second section 414 is not part of the first winding 410. When the second switch 406 is in the second state, the second section 414 is part of the first winding 410. When the third switch 408 is in the first state, the third section 416 is not part of the first winding 410. When the third switch 408 is in the second state, the third section 416 is part of the first winding 410.

As a result, the transformer assembly 400 has up to at least eight modes of operation depending on which sections 412, 414, 416, 418 are part of the first winding 410. Suppose the fourth section 418 has 70 turns, the third section 416 has 40 turns, the second section 414 has 20 turns, and the first section has 10 turns. Suppose the second winding 322 has 100 turns. Then some possible modes of operation are summarized in Table 4, below.

TABLE 4
Modes of Operation of Fourth AVR Transformer

| | Connected Sections of | Output Voltage (relative | |
|---|---|---|---|
| Mode | First Winding | to input voltage) | |
| Triple Boost | Fourth | 1.43 | Vin |
| Double Boost | Fourth, and First | 1.25 | Vin |
| Boost | Fourth, and Second | 1.11 | Vin |
| Normal | Fourth, Second, and First | 1.0 | Vin |
| Trim | Fourth, and Third | 0.91 | Vin |
| Double Trim | Fourth, Third, and First | 0.83 | Vin |
| Triple Trim | Fourth, Third, and Second | 0.77 | Vin |
| Quatro Trim | Fourth, Third, Second and | 0.71 | Vin |
| | First | | |

The topology of the fourth transformer assembly 400 may be extended indefinitely. That is, additional switches and winding sections may be added to the first winding 410 and connected in like manner to the existing switches 404, 406, 408 and sections 412, 414, 416. Adding additional sections increases the number of operation modes in exponential fashion such that the total number of operating modes may be equal to (2″-1), where n is the number of switch-and-section pairs.

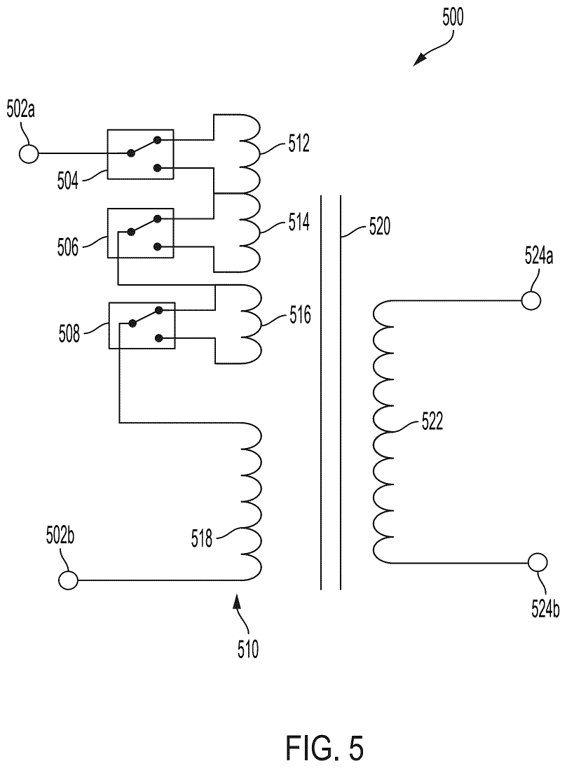

FIG. 5 illustrates a fifth AVR transformer assembly 500 (“transformer assembly 500”) according to an example. The transformer assembly 500 is generally similar to transformer assembly 300 of FIG. 3 except that an additional switch and section of the first winding is present, which increases the number of modes of operation.

The transformer assembly 500 includes a first input 502a, a second input 502b, a first switch 504, a second switch 506, a third switch 508, a first winding 510 having a first section 512, a second section 514, a third section 516, and a fourth section 518, a core 520, a second winding 522, a first output 524a, and a second output 524b.

The first input 502a is coupled to a first terminal of the first switch 505. A second terminal of the first switch 505 is coupled to the first end of the first section 512, and a third terminal of the first switch 505 is coupled to a second end of the first section 512. A first terminal of the second switch 506 is coupled to a first end of the third section 516, a second terminal of the second switch 506 is coupled to a first end of the second section 514, and a third terminal of the second switch 506 is coupled to the second end of the second section 514. A first terminal of the third switch 508 is coupled to the first end of the fourth section 518, a second terminal of the third switch 508 is coupled to the first end of the third section 516, and a third terminal of the third switch 508 is coupled to the second end of the third section 516. The second input 502b is coupled to the second end of the fourth section 518. The core 520 may be interposed within and/or between the first and second windings 510, 522. The first output 524a is coupled to a first end of the second winding 522, and the second output 524b is coupled to a second end of the second winding 522.

Each switch 504, 506, 508 may have two or more states, including a first state when the respective switch's respective first terminal is selectively coupled to the respective second terminal, and a second state when the first terminal is coupled to the respective third terminal. When the first switch 504 is in the first state, the first section 512 is part of the first winding 510. When the first switch 504 is in the second state, the first section 512 is not part of the first winding 510. When the second switch 506 is in the first state, the second section 514 is not part of the first winding 510. When the second switch 506 is in the second state, the second section 514 is part of the first winding 510. When the third switch 508 is in the first state, the third section 516 is not part of the first winding 510. When the third switch 508 is in the second state, the third section 516 is part of the first winding 510.

As a result, the transformer assembly 500 has up to at least eight modes of operation depending on which sections 512, 514, 516, 518 are part of the first winding 510. Suppose the fourth section 518 has 70 turns, the third section 516 has 50 turns, the second section 514 has 20 turns, and the first section has 10 turns. Suppose the second winding 322 has 100 turns. Then some possible modes of operation are summarized in Table 5, below.

TABLE 5
Modes of Operation of Fifth AVR Transformer

| | Connected Sections of | Output Voltage (relative | |
|---|---|---|---|
| Mode | First Winding | to input voltage) | |
| Triple Boost | Fourth | 1.43 | Vin |
| Double Boost | Fourth, and First | 1.25 | Vin |
| Boost | Fourth, and Second | 1.11 | Vin |
| Normal | Fourth, Second, and First | 1.0 | Vin |
| Trim | Fourth, and Third | 0.91 | Vin |
| Double Trim | Fourth, Third, and First | 0.83 | Vin |
| Triple Trim | Fourth, Third, and Second | 0.77 | Vin |
| Quatro Trim | Fourth, Third, Second and | 0.71 | Vin |
| | First | | |

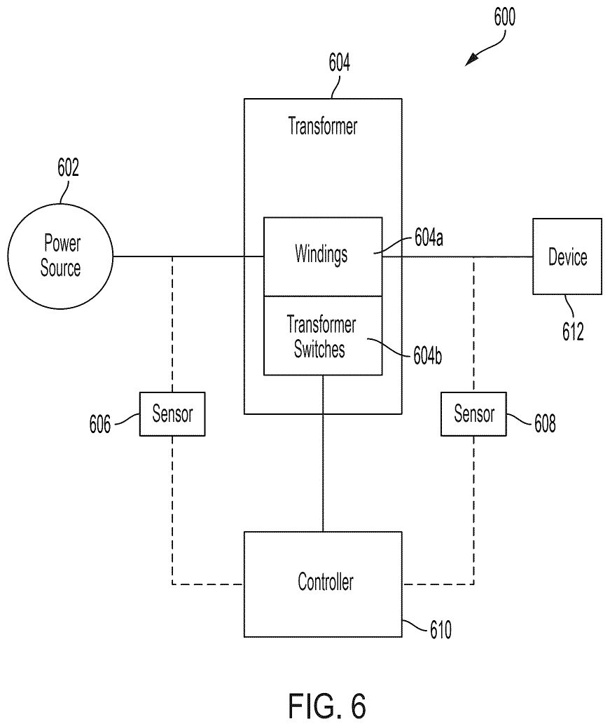

FIG. 6 illustrates a system 600 using an AVR transformer assembly 604 (“transformer assembly 604”) to provide a regulated output voltage to a device 612 according to an example. The regulated output voltage may be a voltage that remains within a range of acceptable voltages even if the regulated output voltage is not constant.

The system 600 includes a power source 602, a transformer assembly 604 having a plurality of windings 604a (“windings 604a”) and transformer switches 604b (“switches 604b), a first sensor 606, a second sensor 608, one or more controllers 610 (“controller 610”), and a device 612.

The power source 602 is coupled to at least the primary winding of the windings 604a. The device 612 is coupled to at least the secondary winding of the windings 604a. The switches 604b may be coupled to various sections of the windings 604a, for example, of the primary winding and/or secondary winding. In some examples, the switches 604b may be coupled to sections of only one of the windings 604a, for example, only the primary winding or only the secondary winding. The switches 604b are also coupled to the controller 610. The first sensor 606 may be coupled to the controller 610, the power source 602, the transformer assembly 604, the primary winding of the windings 604a, or any bus connecting the power source 602 and transformer assembly 604. The first sensor 606 may also be independently situated. The second sensor 608 may be coupled to the device 612, the transformer assembly 604, the secondary winding of the windings 604a, or to any bus connecting the device 612 to the transformer assembly 604. The second sensor 608 may also be independently situated. The controller 610 may be coupled to the sensors 606, 608 or configured to receive signals from the sensors 606, 608. The controller 610 may also be operatively coupled to the switches 604b such that the controller 610 can control the state of the switches 604b.

The power source 602 provides an input voltage to the primary winding of the windings 604a of the transformer. The input voltage may be equal to the voltage at the output of the power source 602 coupled to the transformer assembly 604 or may be different (for example, if impedances exist between the output of the power source 602 and the primary winding). The input voltage may reflect, indicate, or be the voltage present on the primary winding of the windings 604a.

The first sensor 606 may be configured to sense the input voltage as well as current, power, harmonics, or any other characteristics associated with the input voltage, and may provide a signal indicative of the input voltage or other characteristics to the controller 610.

The transformer assembly 604, in some examples, may be implemented using any of the transformers 100, 200, 300, 400, 500 of FIGS. 1-5. The transformer is configured to receive an input voltage on the primary winding of the windings 604a and provide a regulated output voltage (that is, a voltage that remains within an acceptable range of voltages) to the device 612 via at least the secondary winding of the windings 604a. The switches 604b may be configured to selectively couple and/or decouple discrete sections of a given winding from that winding. For example, the switches 604b may be the switches 104, 106 in FIG. 1, or may be any of the switches identified in FIGS. 2-5 and may be coupled to the primary and/or secondary winding of the windings 604a in like manner to how the switches of FIGS. 1-5 are coupled to the first windings of FIGS. 1-5.

The second sensor 608 is configured to sense the value of the regulated output voltage and provide a signal indicating the value of the regulated output voltage to the controller 610.

The second sensor 608 may also detect current, power, harmonics, or any other characteristics associated with the regulated output voltage and provide a signal indicative of those characteristics to the controller 610.

The controller 610 may use the input voltage value from the first sensor 606 and/or the regulated output voltage value from the second sensor 608 to control the state of the switches 604b and therefore control the number of turns of a given winding of the windings 604a.

For example, since the number of turns on each winding may be predetermined for each possible state based on the states of the switches 604b, the controller 610 may determine the regulated output voltage based on only the input voltage, or may determine the input voltage based on only the regulated output voltage, for example by using the relationship in equation (1) above. As the input voltage and regulated output voltage are related, using either the value of the input voltage and/or the regulated output voltage, the controller 610 can determine whether the regulated output voltage falls outside the acceptable range (or whether the input voltage falls outside an acceptable range for the present configuration of the switches 604b), and then may control the switches 604b to adjust the state of the windings 604a, for example by changing the number of turns on the primary winding and/or on the secondary winding to adjust the regulated output voltage and bring it back into the acceptable range.

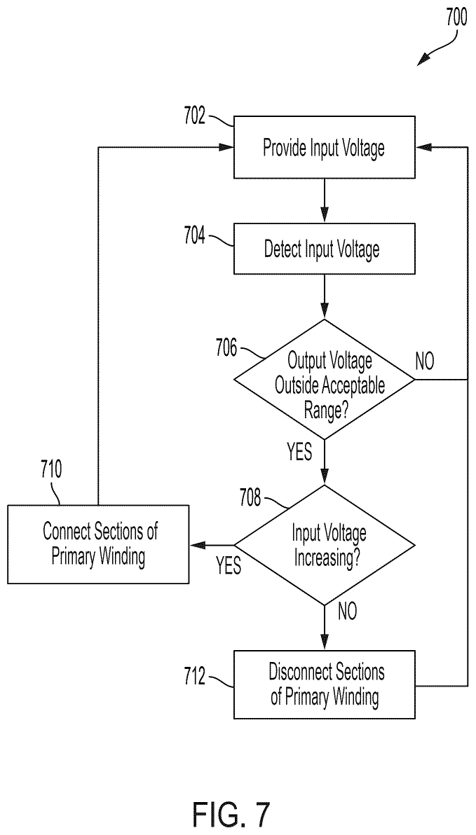

FIG. 7 illustrates a process 700 for controlling an AVR transformer assembly, such as those disclosed herein, according to an example.

At act 702, an input voltage is provided by a power source, for example the power source 602 of FIG. 6, to the primary winding of a transformer, for example, the first winding 108 of FIG. 1. The input voltage may fall within a range of acceptable voltage values or within a range of voltages dictated by the maximum and minimum voltages provided by the voltage source (e.g., a power source such as a battery, generator, mains or utility power line, and so forth). The process 700 then proceeds to act 704.

At act 704, a sensor, for example the first sensor 606 or second sensor 608, detects the input or output voltage and provides a signal to a controller, for example the controller 610 of FIG. 6. The process 700 may then continue to act 706.

At act 706, the controller determines whether the output voltage is outside an acceptable range. For example, the controller may compare the output voltage value provided by the sensor to an acceptable range of voltages for the output voltage. If the controller determines the output voltage does not fall within an acceptable range (706 YES), the process 700 may continue to act 708. IF the controller determines the output voltage does fall within an acceptable range (706 NO), the process 700 may return to act 702.

At act 708, the controller determines whether the input voltage is increasing or decreasing or above a first threshold or below a second threshold (for example, if the input voltage deviates from an acceptable voltage range or from an acceptable voltage by more than a threshold amount). The controller may receive a direct indication of the input voltage value from a sensor and compare it to previous indications of the input voltage value, or may determine whether the output voltage is above or below the acceptable range, and then, based on the current state of the switches (for example, switches 604b of FIG. 6), determine whether the input voltage is increasing or decreasing. If the controller determines the input voltage is increasing (708 YES), the process 700 may continue to act 710. If the controller determines the input voltage is decreasing (708 NO), the process 700 may continue to act 712.

At act 710, the controller controls the switches to connect one or more sections of the primary winding of the transformer to the primary winding (for example, the primary winding of the windings 604a of FIG. 6). Put another way, if the input voltage is increasing (or above a threshold), the controller may control the transformer to switch to a trim mode of operation by adjusting the states of the switches to connect more sections of the primary winding to the conducting path of the primary winding. The process 700 may then return to act 702.

At act 712, the controller operates the switches to disconnect one or more sections of the primary winding of the transformer from the primary winding. Put another way, if the input voltage is decreasing (or below a threshold), the controller may control the transformer to switch to a boost mode of operation by adjusting the states of the switches to disconnect sections of the primary winding from the conducting path of the primary winding.

Switches discussed herein may be transistors, relays, multi-pole switches, or any other type of switching device.

Examples of the methods and systems discussed herein are not limited in application to the details of construction and the arrangement of components set forth in the description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Various controllers, such as the controller 610, may execute various operations discussed above. Using data stored in associated memory and/or storage, the controller 610 also executes one or more instructions stored on one or more non-transitory computer-readable media, which the controller 610 may include and/or be coupled to, that may result in manipulated data. In some examples, the controller 610 may include one or more processors or other types of controllers. In one example, the controller 610 is or includes at least one processor. In another example, the controller 610 performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A transformer assembly comprising:
a first input;
a second input;
a first output;
a second output;
a first winding including
a first tap, a second tap, a third tap, and a fourth tap,
a first switching device having a first input terminal, a first tap terminal coupled to the first tap, a second tap terminal coupled to the second tap, the first switching device being configured to selectively couple the first input terminal to the first tap terminal or the second tap terminal, and
a second switching device having a second input terminal, a third tap terminal coupled to the third tap, a fourth tap terminal coupled to the fourth tap, the second switching device being configured to selectively couple the second input terminal to the third tap terminal or the fourth tap terminal; and
a second winding galvanically isolated from the first winding and coupled to the first output and the second output.

2. The transformer assembly of claim 1 wherein the first input terminal is coupled to the first input.

3. The transformer assembly of claim 1 wherein the second input terminal is coupled to the second input.

4. The transformer assembly of claim 1 wherein the first winding includes a first end and a second end, and the first tap is situated at the first end, the fourth tap is situated at the second end, the second tap is situated between the first tap and the fourth tap, and the third tap is situated between the second tap and the fourth tap.

5. The transformer assembly of claim 1 wherein the first winding includes a first section, a second section, and a third section, wherein the first tap is coupled to a first end of the first section, the second tap is coupled to a second end of the first section, the third tap is coupled to a first end of the second section, and the fourth tap is coupled to a second end of the second section.

6. The transformer assembly of claim 5 wherein the first tap is further coupled to the first input, the third tap is coupled to the first input terminal, a first end of the third section is coupled to the second input terminal, and a second end of the third section is coupled to the second input.

7. The transformer assembly of claim 6 wherein the first section, second section, and third section are physically separate sections.

8. The transformer assembly of claim 5 wherein the second tap and third tap are a same tap, a first end of the third section is coupled to the second input terminal, a second end of the third section is coupled to the second input, and the first input terminal is coupled to the first input.

9. The transformer assembly of claim 8 wherein the first section and second section are physically separate from the third section.

10. The transformer assembly of claim 5 wherein the first winding includes a fourth section having a first end of the fourth section and a second end of the fourth section, wherein a fifth tap is coupled to the first end of the fourth section, and a sixth tap is coupled to the second end of the fourth section, and the transformer further comprises
a third switch having a third input terminal, a fifth tap terminal coupled to the fifth tap, and a sixth tap terminal coupled to the sixth tap.

11. The transformer assembly of claim 10 wherein the first end of the third section is coupled to the third input terminal, the fifth tap is coupled to the second input terminal, the third tap is coupled to the first input terminal, and the first end of the first section is coupled to the first input.

12. The transformer assembly of claim 10 wherein the first section, second section, third section, and fourth section are physically separate sections.

13. The transformer assembly of claim 1 further comprising a core electromagnetically coupled to the first winding and the second winding.

14. A method of regulating a voltage, comprising:
provide a voltage to a first winding of a transformer;
determine that an output voltage provided by a second winding of the transformer has changed by a threshold amount;
responsive to determining that the output voltage has changed by a threshold amount, setting a first switch position of a first switch to one of a first state of the first switch and a second state of the first switch, the first state of the first switch configured to provide the voltage to a first section of the first winding, and the second state of the first switch configured to disconnect the first section of the first winding from the voltage;
responsive to determining that the output voltage has changed by a threshold amount, setting a second switch position of a second switch to one of a first state of the second switch and a second state of the second switch, the first state of the second switch configured to provide the voltage to a second section of the first winding, and the second state of the second switch configured to disconnect the second section of the first winding from the voltage; and
responsive to determining that the output voltage has changed by a threshold amount, providing the voltage to a third section of the first winding regardless of the first switch position or the second switch position.

15. The method of regulating voltage of claim 14, further comprising, responsive to determining that the output voltage has changed by a threshold amount, setting a third switch position of a third switch to one of a first state of the third switch and a second state of the third switch, the first state of the third switch configured to provide the voltage to a fourth section of the first winding, and the second state of the third switch configured to disconnect the third section of the first winding from the voltage.

16. The method of claim 16 wherein the voltage is provided to the third section regardless of the third switch position.

17. The method of claim 14 wherein providing the voltage to the second section of the first winding further includes providing the voltage to the second section from the first switch.

18. A non-transitory computer-readable medium containing thereon instructions for regulating voltages, the instructions instructing one or more processors to:
receive an indication of an output voltage and an input voltage of a transformer;
determine whether the output voltage has changed by a threshold amount;
responsive to determining that the output voltage has changed by a threshold amount, adjust a first switch position of a first switch of a transformer to selectively provide or remove the input voltage from a first section of the first winding;
responsive to determining that the output voltage has changed by the threshold amount, adjust a second switch position of a second switch of the transformer to selectively provide or remove the input voltage from a second section of the first winding; and
provide the input voltage to a third section of the first winding regardless of the first switch position and the second switch position.

19. The non-transitory computer-readable medium of claim 18 wherein the instructions further instruct the one or more processors to, responsive to determining that the output voltage has changed by a threshold amount, adjust a third switch position of a third switch of the transformer to selectively provide or remove the input voltage from a fourth section of the first winding; and
provide the input voltage to the third section regardless of the third switch position.

20. The non-transitory computer-readable medium of claim 18 wherein the input voltage is a voltage associated with the first winding, and the output voltage is a voltage associated with a second winding.

21. A transformer assembly comprising:
a first input;
a second input;
a first winding having a plurality of sections including a first section and a last section, a first end of the first section being coupled to the first input and a second end of the last section being coupled to the second input;
a plurality of switches including a first switch configured to selectively couple the first end of the first section or a second end of the first section to a first end of a next section, and a last switch configured to couple a first end of the last section to a first end of a penultimate section or a second end of the penultimate section; and
a second winding galvanically isolated from the first winding.

22. A transformer assembly comprising:
a first input;
a second input;
a first winding having a plurality of sections including
a first section having a first end of the first section and a second end of the first section,
a last section having a first end of the last section and a second end of the last section,
a next section having a first end of the next section, and
a penultimate section having a first end of the penultimate section and a second end of the penultimate section, the second end of the last section being coupled to the second input, and the second end of the first section being coupled to the first end of the next section;
a plurality of switches including a first switch and a last switch,
the first switch being coupled to the first input, the first end of the first section, and the second end of the first section, and configured to selectively couple the first input to the first end of the first section or the second end of the first section, and
the second switch being coupled to the first end of the last section, the first end of the penultimate section, and the second end of the penultimate section, the last switch configured to selectively couple the first end of the last section to the first end of the penultimate section or the second end of the penultimate section; and
a second winding galvanically isolated from the first winding.
